(19) United States
(12) Patent Application Publication
(10) Pub. No.: US 2019/0197639 A1
(43) Pub. Date: Jun. 27, 2019

(54) SYSTEM, METHOD, AND PROGRAM FOR MANAGING CONTRACT

(71) Applicant: OPTiM Corporation, Saga (JP)

(72) Inventor: Shunji SUGAYA, Tokyo (JP)

(21) Appl. No.: 15/544,108

(22) PCT Filed: Aug. 31, 2016
(86) PCT No.: PCT/JP2016/075482

§ 371 Date: Jul. 17, 2017

(51) Int. Cl. G06Q 50/18; G06F 17/27; G06Q 10/06

(52) U.S. Cl. CPC G06Q 50/188; G06Q 10/0635; G06F 17/278

(57) ABSTRACT

The system for managing a contract previously informs the risk and appropriately renews and manages the contract. The system for managing a contract includes a keyword detection module 111 that detects a predetermined keyword in the text of the contract; an important part recognition module 112 that recognizes an important part for a user who makes a contract based on the detected keywords; and an attention degree change module 151 that changes an attention degree to the recognized important part.

### TECHNICAL FIELD

The present invention relates to a system, a method, and a program for managing a contract to clearly display information including the contract period, the type, and the counterparty of the contract that is important for a user who makes a contract on the screen, etc., of a terminal, previously inform the risk, and appropriately renew and manage the contract.

### BACKGROUND ART

As a method for preparing a contract document, a system that manages a contract with increasing the efficiency of the input and the management of the contract by prompting the customer to input the contract to a tablet terminal is disclosed (Patent Document 1).

### CITATION LIST

### Patent Literature

Patent Document 1: JP 2009-48416 A

### SUMMARY OF INVENTION

However, in the system of Patent Document 1, a person merely inputs a contract. This may cause the person to make a contract although it is unclear what risks arise from the contract period, the type, the counterpart, etc., of the contract.

In addition, Patent Document 1 does not describe contract renewal, access control, etc., for a customer's contract. Thus, Patent Document 1 cannot deal with the cases where the user wishes to appropriately manage two or more contracts and where two or more users using this system wishes to appropriately ensure the security.

In view of the above-mentioned problems, an objective of the present invention is to provide a system, a method, and a program for managing a contract to clearly display information including the contract period, the type, and the counterparty of the contract that is important for a user who makes a contract on the screen, etc., of a terminal, previously inform the risk, and appropriately renew and manage the contract.

The first aspect of the present invention provides a system for managing a contract, including:

a keyword detection unit that detects a predetermined keyword in the text of the contract;

an important part recognition unit that recognizes an important part for a user who makes a contract based on the detected keywords; and

an attention degree change unit that changes an attention degree to the recognized important part.

According to the first aspect of the present invention, a system for managing a contract includes a keyword detection unit that detects a predetermined keyword in the text of the contract; an important part recognition unit that recognizes an important part for a user who makes a contract based on the detected keywords; and an attention degree change unit that changes an attention degree to the recognized important part.

The first aspect of the present invention is the category of a system for managing a contract, but the categories of a method and a program for managing a contract have similar functions and effects.

The second aspect of the present invention provides the system according to the first aspect of the present invention, further including: a contract period recognition unit that recognizes the contract period based on the detected keywords; and a contract period renewal unit that renews the recognized contract period to a predetermined period.

According to the second aspect of the present invention, the system according to the first aspect of the present invention further includes: a contract period recognition unit that recognizes the contract period based on the detected keywords; and a contract period renewal unit that renews the recognized contract period to a predetermined period.

The third aspect of the present invention provides the system according to the first or the second aspect of the present invention, further including: a contract type recognition unit that recognizes the contract type based on the detected keywords; and a contract categorizing unit that categorizes the contract based on the recognized contract type.

According to the third aspect of the present invention, the system according to the first or the second aspect of the present invention further includes: a contract type recognition unit that recognizes the contract type based on the detected keywords; and a contract categorizing unit that categorizes the contract based on the recognized contract type.

The fourth aspect of the present invention provides the system according to any one of the first to the third aspects of the present invention, further including: a contract ID assigning unit that assigns an ID to the contract; a user ID assigning unit that assigns an ID to the user; an ID-associated information storing unit that associates and stores the contract ID with the user ID as ID-associated information; and a contract access control unit that controls an access from the user to the contract based on the stored ID-associated information.

According to the fourth aspect of the present invention, the system according to any one of the first to the third aspects of the present invention further includes: a contract ID assigning unit that assigns an ID to the contract; a user ID assigning unit that assigns an ID to the user; an ID-associated information storing unit that associates and stores the contract ID with the user ID as ID-associated information; and a contract access control unit that controls an access from the user to the contract based on the stored ID-associated information.

The fifth aspect of the present invention provides the system according to any one of the first to the fourth aspects of the present invention, further including: a counterpart recognition unit that recognizes a counterpart based on the detected keywords; and a counterpart corporate information management unit that manages corporate information on the recognized counterpart, in which the important part recognition unit recognizes the important part based on the counterpart or the corporate information thereof.

According to the fifth aspect of the present invention, the system according to any one of the first to the fourth aspects of the present invention further includes: a counterpart recognition unit that recognizes a counterpart based on the detected keywords; and a counterpart corporate information management unit that manages corporate information on the recognized counterpart, in which the important part recognition unit recognizes the important part based on the counterpart or the corporate information thereof.

The sixth aspect of the present invention provides the system according to the fifth aspect of the present invention further including a contract risk judgment unit that judges the risk of the contract based on at least one of the detected keyword, the detected counterpart, and the corporate information thereof, in which the attention degree change unit displays an attention degree in stages according to the judged risk of the contract.

According to the sixth aspect of the present invention, the system according to the fifth aspect of the present invention further includes a contract risk judgment unit that judges the risk of the contract based on at least one of the detected keyword, the detected counterpart, and the corporate information thereof, in which the attention degree change unit displays an attention degree in stages according to the judged risk of the contract.

The seventh aspect of the present invention provides a method for managing a contract, including the steps of:

detecting a predetermined keyword in the text of the contract;

recognizing an important part for a user who makes a contract based on the detected keywords; and

changing an attention degree to the recognized important part.

The eighth aspect of the present invention provides a program for causing a system for managing a contract to execute the steps of:

detecting a predetermined keyword in the text of the contract;

recognizing an important part for a user who makes a contract based on the detected keywords; and

changing an attention degree to the recognized important part.

The present invention can provide a system, a method, and a program for managing a contract to clearly display information including the contract period, the type, and the counterparty of the contract that is important for a user who makes a contract on the screen, etc., of a terminal, previously inform the risk, and appropriately renew and manage the contract.

### BRIEF DESCRIPTION OF DRAWINGS

FIG. 1 shows a schematic diagram of a preferable embodiment of the present invention.

FIG. 2 shows a functional block diagram of the terminal 100 to show the relationship among the functions.

FIG. 3 shows a flow chart of the attention degree change process performed by the terminal 100.

FIG. 4 shows a functional block diagram of the terminal 100 with a contract period renewal function to show the relationship among the functions.

FIG. 5 shows a flow chart of the contract period renewal process performed by the terminal 100.

FIG. 6 shows a functional block diagram of the terminal 100 with a contract categorizing function to show the relationship among the functions.

FIG. 7 shows a flow chart of the contract categorizing process performed by the terminal 100.

FIG. 8 shows a functional block diagram of the terminal 100 and the computer 200 with an ID-associated information storing function and a contract access control function to show the relationship among the functions.

FIG. 9 shows a flow chart of the ID-associated information storing process performed by the terminal 100 and the computer 200.

FIG. 10 shows a flow chart of the contract access control process performed by the terminal 100 and the computer 200.

FIG. 11 shows a functional block diagram of the terminal 100 and the computer 200 with a risk judgement function to show the relationship among the functions.

FIG. 12 shows a flow chart of the contract risk judgement process.

FIG. 13 shows one example displayed by the attention degree change process.

FIG. 14 shows one example displayed by the contract period renewal process.

FIG. 15 shows one example displayed by the contract risk judgement process.

### DESCRIPTION OF EMBODIMENTS

Embodiments of the present invention will be described below with reference to the attached drawings. However, this is illustrative only, and the technological scope of the present invention is not limited thereto.

### Overview of System for Managing a Contract

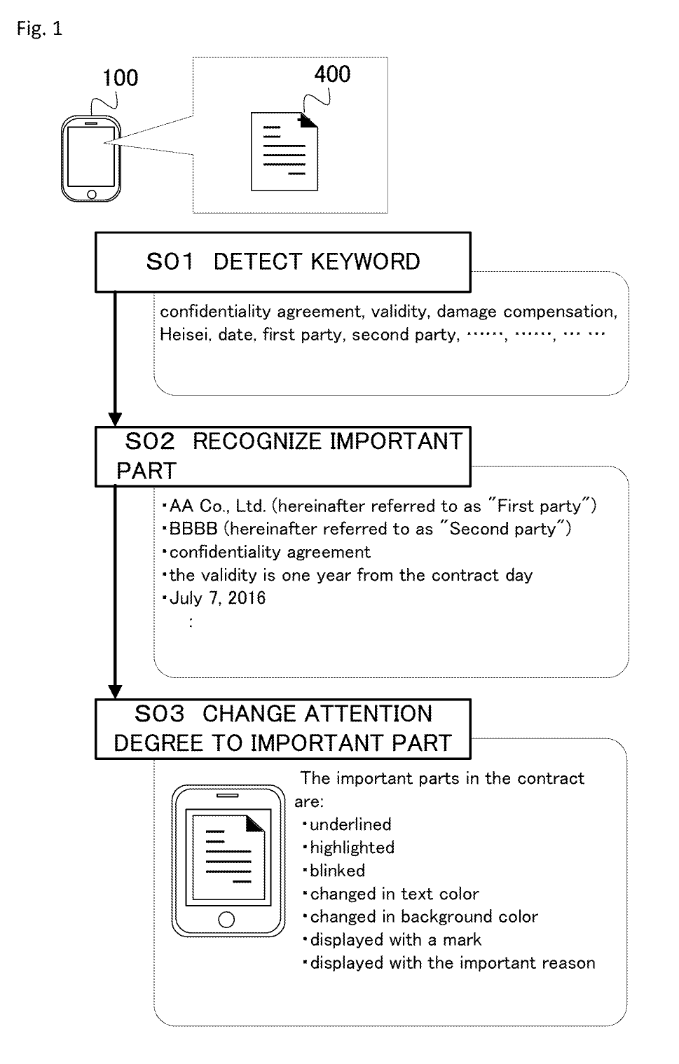

FIG. 1 shows a schematic diagram of a preferable embodiment of the present invention. The overview of the present invention will be described below with reference to FIG. 1.

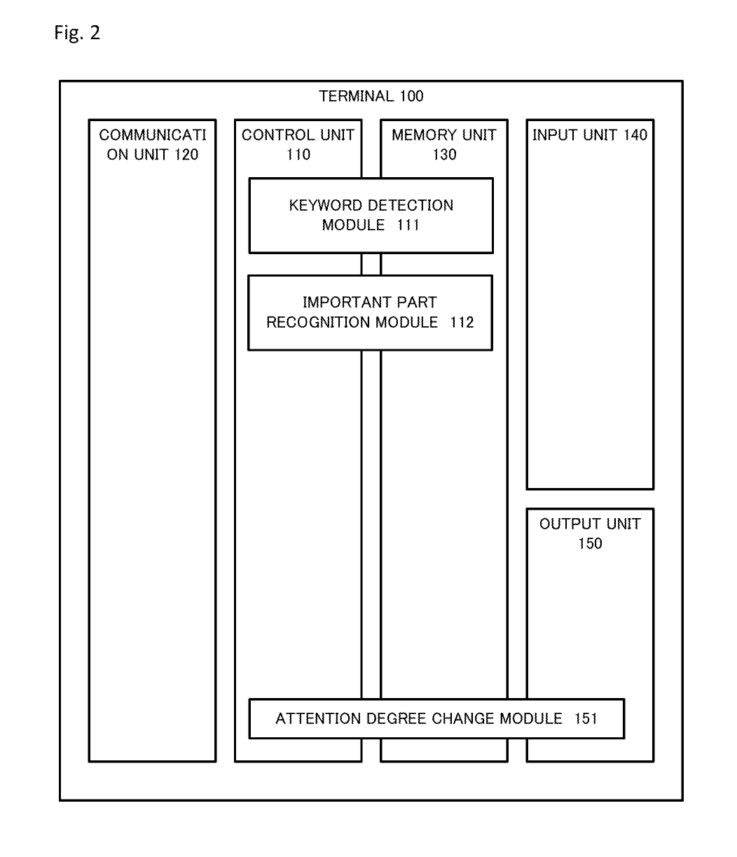

The terminal 100 includes a control unit 110, a communication unit 120, a memory unit 130, an input unit 140, and an output unit 150 as shown in FIG. 2. The control unit 110 achieves a keyword detection module 111 and an important part recognition module 112 in cooperation with the memory unit 130. The output unit 150 achieves an attention degree change module 151 in cooperation with the control unit 110 and the memory unit 130.

The terminal 100 is a terminal device owned by the user who uses the system for managing a contract. Examples of the terminal 100 include electrical appliances such as a mobile phone, a mobile information terminal, a tablet terminal, a personal computer, a net book terminal, a slate terminal, an electronic book terminal, and a portable music player, and wearable terminals such as smart glasses and a head mounted display. The smart phone shown as the terminal 100 in the attached drawings is just one example.

In the system for managing a contract shown in FIG. 1, the keyword detection module 111 of the terminal 100 first detects a keyword in a contract 400 to be managed (Step S01). The contract 400 may be acquired through the communication unit 120 or by subjecting the document imaged by the camera of the terminal 100 to an optical character recognition (hereinafter referred to as “OCR”) process.

The keyword is a word or a phrase that can be used to judge the contract period, the contract type, the contractor, the counterpart, the risk, the payment, etc. Examples of the keyword to judge the contract period may include date, contract day, and validity. Examples of the keyword to judge the contract type may include confidentiality, sales, job commission, and licensing. Examples of the keyword to judge the counterpart may include company, first party, second party, chairman, president, director, and manager. Examples of the keyword to judge the risk and the payment may include damage compensation, obligation, liability, must, prohibition, payment, consideration, and yen. The keyword may be input by the user with the input unit 140 of the terminal 100 or from the outside through the communication unit 120 of the terminal 100.

FIG. 1 illustrates that “confidentiality agreement,” “validity,” “damage compensation,” “Heisei,” “date,” “first party,” “second party,” etc., were detected in a contract 400 as the keywords.

Then, the important part recognition module 112 of the terminal 100 recognizes an important part based on the detected keywords (Step S02). The important part herein is important for the user (contractor) who makes a contract. Examples of the important part include a contract period, a contract type, a counterpart, a risk, and a payment.

To recognize an important part, a person may learn the important part from a teacher or may use machine learning and deep learning. For the learning, a large amount of data is needed so that the important part recognition module that has 112 has learned an important part may be acquired from the outside through the communication unit 120.

FIG. 1 illustrates that “AA Co., Ltd. (hereinafter referred to as “First party”),” “BBBB (hereinafter referred to as “Second party”),” “confidentiality agreement,” “the validity is one year from the contract day,” “Jul. 7, 2016,” etc., were recognized as the important parts based on the detected keywords.

Finally, the attention degree change module 151 of the terminal 100 changes the attention degree to each recognized important part (Step S03). Specifically, in the attention degree process, the important parts may be underlined, highlighted, blinked, changed in text color, changed in background color, displayed with a mark indicating the importance, or displayed with the important reason in a contract 400 displayed on the output unit 150 of the terminal 100. If the important parts are output by voices, the start and end of each important part may be guided audibly.

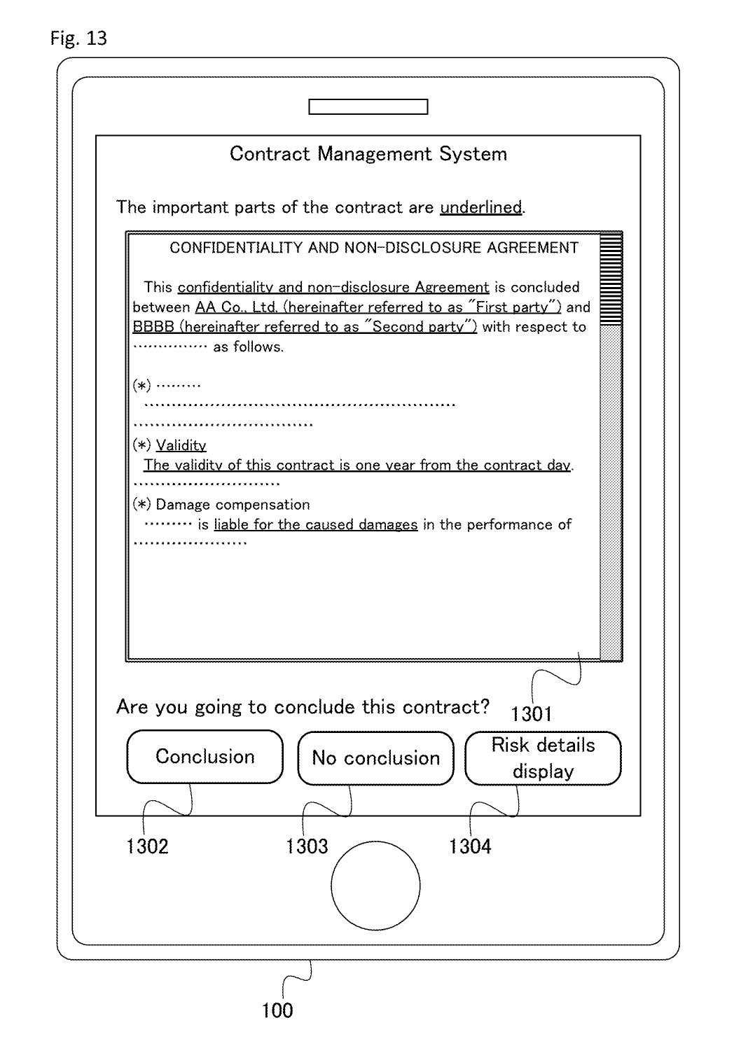

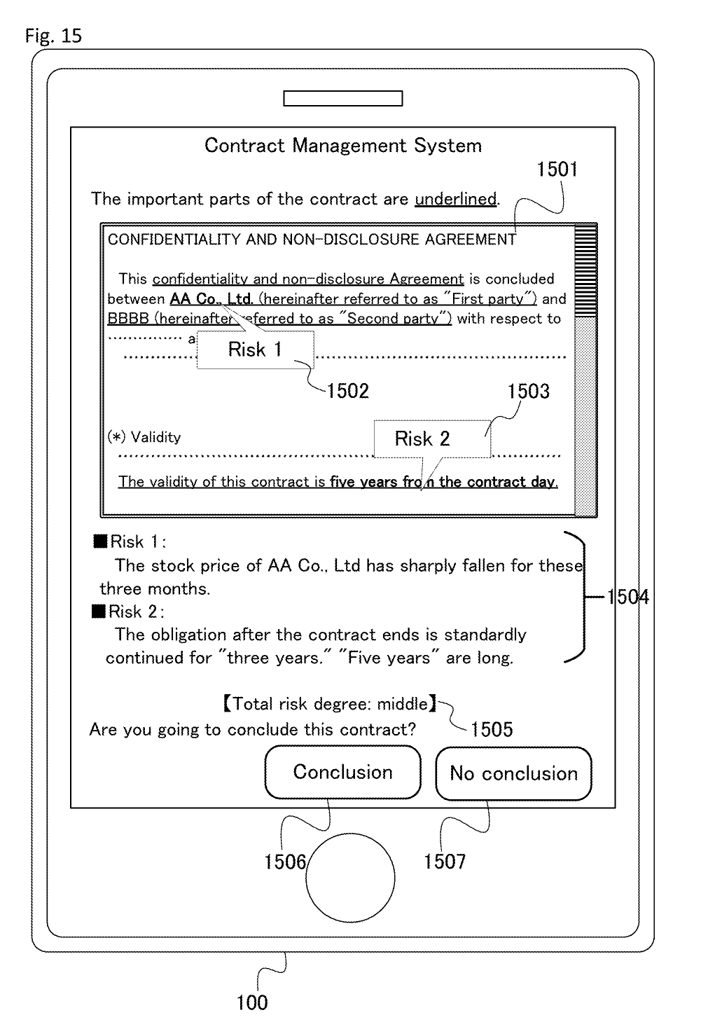

FIG. 13 shows one example displayed by the attention degree change process. The output unit 150 of the terminal 100 displays a contract 400. The attention degree change module 151 outputs the content of the contract 400 on the display unit 1301 while changing the attention degree to each important part. If all the content cannot be displayed on the display unit 1301, scrolling the text or flipping the pages enables the user to view the full text. As shown in the upper part of the screen, an important part of the contract may be underlined to show additional explanation that the attention degree has been changed. In this example, the changed attention degrees are underlined but may be displayed in other ways. Selecting the conclusion button 1302 on this screen concludes this contract. If a contract 400 is acquired through the communication unit 120, the contract conclusion process may be continued by the control unit 110 through the communication unit 120. If a written contract 400 is acquired by an OCR process, the conclusion of the contract in writing may be stored in the memory unit 130 of the terminal 100. Selecting the no conclusion button 1303 does not perform the conclusion process for the contract. If a contract 400 is acquired through the communication unit 120, the contract conclusion process may be ended by the control unit 110 through the communication unit 120. If a written contract 400 is acquired by an OCR process, the no-conclusion of the contract in writing may be stored in the memory unit 130 of the terminal 100. After the process of the conclusion button 1302 and the no conclusion button 1303 ends, the system for managing a contract may be ended, or the menu screen, etc., of the system for managing a contract may be displayed. Selecting risk details display button 1304 on this screen displays a possible risk details after this contract 400 is concluded. The example of the screen when the risk details display button 1304 is selected will be described later in the description about FIG. 15.

As described above, the present invention can provide a system, a method, and a program for managing a contract to clearly display information including the contract period, the type, and the counterparty of the contract that is important for a user who makes a contract on the screen, etc., of a terminal, and previously inform the risk.

### Functions

FIG. 2 shows a functional block diagram of the user terminal 100 to show the relationship among the functions. The terminal 100 includes a control unit 110, a communication unit 120, a memory unit 130, an input unit 140, and an output unit 150. The control unit 110 achieves a keyword detection module 111 and an important part recognition module 112 in cooperation with the memory unit 130. The output unit 150 achieves an attention degree change module 151 in cooperation with the control unit 110 and the memory unit 130.

Examples of the terminal 100 include electrical appliances such as a mobile phone, a mobile information terminal, a tablet terminal, a personal computer, a net book terminal, a slate terminal, an electronic book terminal, and a portable music player, and wearable terminals such as smart glasses and a head mounted display. The smart phone shown as the terminal 100 in the attached drawings is just one example.

In the terminal 100, the control unit 110 includes a central processing unit (hereinafter referred to as “CPU”), a random access memory (hereinafter referred to as “RAM”), and a read only memory (hereinafter referred to as “ROM”). The control unit 110 achieves a keyword detection module 111 and an important part recognition module 112 in cooperation with the memory unit 130.

The communication unit 120 includes a device that is communicative to other devices, such as a Wireless Fidelity (Wi-Fi®) enabled device complying with, for example, IEEE 802.11, or a wireless device complying with the IMT-2000 standard such as the third and the fourth generation mobile communication systems. The communication unit may include a wired device for LAN connection.

The memory unit 130 includes a data storage unit such as a hard disk or a semiconductor memory to store the data necessary for the process that include the contents of contracts 400, keywords, and important parts.

The input unit 140 has a function necessary to use the system for managing a contract. As an example to achieve the input, the input unit 140 may include a liquid crystal display with a touch panel function, a keyboard, a mouse, a pen tablet, a hardware button on the device, and a microphone to perform voice recognition. The features of the present invention are not limited in particular by the input method.

The output unit 150 has a function necessary to use the system for managing a contract. The output unit 150 achieves an attention degree change module 151 in cooperation with the control unit 110 and the memory unit 130. As an example to achieve the output, the output unit 130 may take forms such as a liquid crystal display, a PC display, and a projector to display images and output voices. The features of the present invention are not limited in particular by the output method.

### Attention Degree Change Process

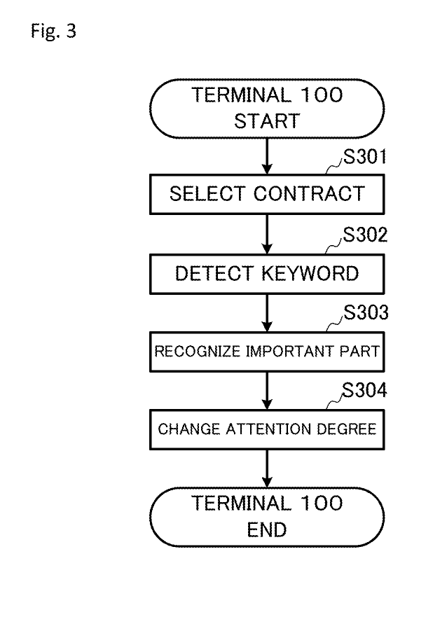

FIG. 3 shows a flow chart of the attention degree change process performed by the terminal 100. The tasks executed by the modules will be described below with this process.

First, the control unit 110 of the terminal 100 selects a contract 400 that is to be managed by the system for managing a contract (Step S301). The contract 400 may be acquired through the communication unit 120 or by subjecting the document imaged by the camera of the terminal 100 to an OCR process or may be acquired by connecting the terminal 100 with another storage media.

Then, the keyword detection module 111 of the terminal 100 detects a keyword in the contract 400 (Step S302).

The keyword is a word or a phrase that can be used to judge the contract period, the contract type, the contractor, the counterpart, the risk, the payment, etc. Examples of the keyword to judge the contract period may include date, contract day, and validity. Examples of the keyword to judge the contract type may include confidentiality, sales, job commission, and licensing. Examples of the keyword to judge the counterpart may include company, first party, second party, chairman, president, director, and manager. Examples of the keyword to judge the risk and the payment may include damage compensation, obligation, liability, must, prohibition, payment, consideration, and yen. The keyword may be input by the user with the input unit 140 of the terminal 100 or from the outside through the communication unit 120 of the terminal 100 or may be acquired by connecting the terminal 100 with another storage media.

Then, the important part recognition module 112 of the terminal 100 recognizes an important part based on the detected keywords (Step S303). The important part herein is important for the user (contractor) who makes a contract. Examples of the important part include a contract period, a contract type, a counterpart, a risk, and a payment.

To recognize an important part, a person may learn the important part from a teacher or may use machine learning and deep learning. For the learning, a large amount of data is needed so that the important part recognition module 112 that has learned an important part may be acquired from the outside through the communication unit 120 or may be acquired by connecting the terminal 100 with another storage media.

For example, if the keyword “first party” is detected in the step S302, the contexts before and after the keyword are checked, and the part “AA Co., Ltd. (hereinafter referred to as “First party”)” is recognized as an important part. If the keyword “confidentiality agreement” is detected, the contexts before and after the keyword are checked, and the keyword “confidentiality agreement” itself may be recognized as an important part.

Finally, the attention degree change module 151 of the terminal 100 changes the attention degree to each recognized important part (Step S304). Specifically, in the attention degree process, the important parts may be underlined, highlighted, blinked, changed in text color, changed in background color, displayed with a mark indicating the importance, or displayed with the important reason in a contract 400 displayed on the output unit 150 of the terminal 100. If the important parts are output by voices, the start and end of each important part may be guided audibly.

FIG. 13 shows one example displayed by the attention degree change process of the terminal 100. The details of this process are as described above.

As described above, the present invention can provide a system, a method, and a program for managing a contract to clearly display information including the contract period, the type, and the counterparty of the contract that is important for a user who makes a contract on the screen, etc., of a terminal, and previously inform the risk.

### Contract Period Renewal Function

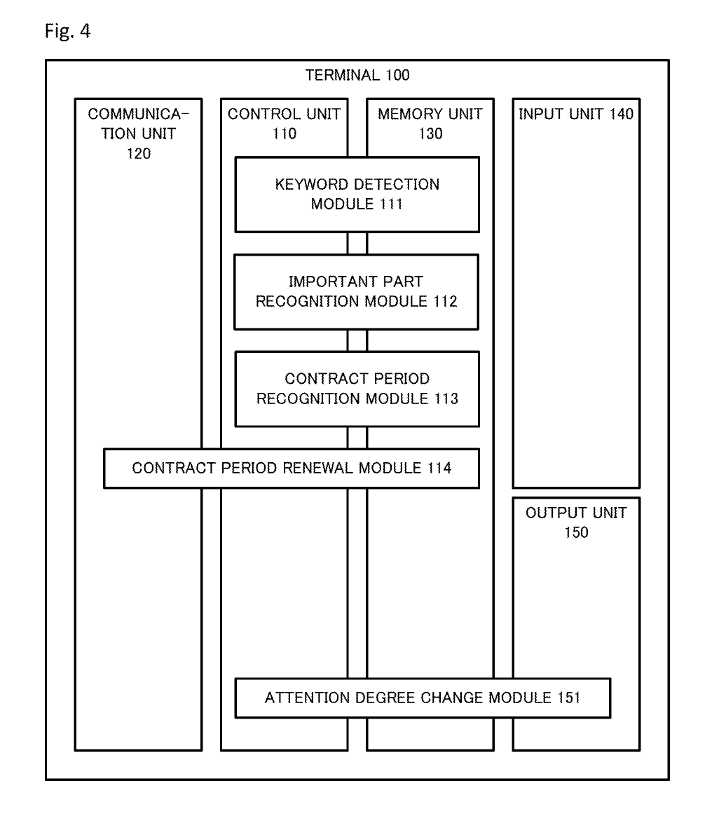

FIG. 4 shows a functional block diagram of the terminal 100 with a contract period renewal function to show the relationship among the functions. In addition to the configuration shown in FIG. 2, the control unit 110 of the terminal 100 achieves a contract period recognition module 113 in cooperation with the memory unit 130. The control unit 110 also achieves a contract period renewal module 114 in cooperation with the communication unit 120 and the memory unit 130.

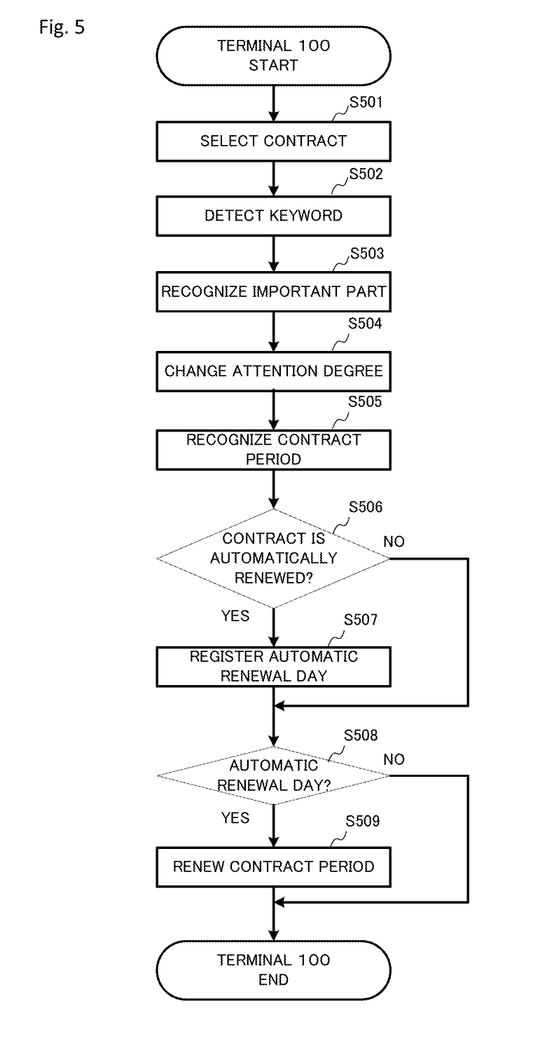

FIG. 5 shows a flow chart of the contract period renewal process performed by the terminal 100. The tasks executed by the modules will be described below with this process. Since the process of the steps S501 to S504 shown in FIG. 5 corresponds to that of the steps S301 to S304 shown in FIG. 3, the process from the step S505 will be described below.

After the attention degree change module 151 changes the attention degree, the contract period recognition module 113 recognizes the contract period (Step S505). The contract period is recognized at this point based on the keywords detected in the step S502. For example, if the keywords “the validity of a contract,” “contract day,” and “year” are detected in the step S502, the contexts before and after the keyword are checked, and the part “the validity is one year from the contract day” is recognized as a contract period. If the keyword “date” is detected, the contexts before and after the keyword are checked, and the “Jul. 7, 2016” is recognized as a contract day. Specifically, since the validity of a contract is one year from the contract day “Jul. 7, 2016,” the contract period is determined as “from Jul. 7, 2016 to 6 Jul. 2017.”

To recognize a contract period, a person may learn the contract period from a teacher or may use machine learning and deep learning. For the learning, a large amount of data is needed so that the contract period recognition module 113 that has learned a contract period may be acquired from the outside through the communication unit 120 or may be acquired by connecting the terminal 100 with another storage media.

Then, the contract period renewal module 114 checks whether or not the contract 400 has been concluded. If the contract 400 has been concluded, the contract period renewal module 114 checks whether or not the contract 400 is automatically renewed (Step S506). Whether or not the contract 400 is automatically renewed may be checked with the user through the output unit 150 and determined in response to a user input from the input unit 140.

If the contract 400 is automatically renewed, the contract period renewal module 114 registers an automatic renewal day in the system for managing a contract (Step S507). Specifically, the contract period renewal module 114 may register the automatic renewal day in the memory unit 130 of the terminal 100. The automatic renewal day may be set to, for example, one month before the contract is terminated in the system or specifically selected by the user. If the automatic renewal day is selected by the user, a day before the contract is terminated should be selected. If the contract is not automatically renewed, the process proceeds to the next step S508.

The contract period renewal module 114 checks whether or not today is the automatic renewal day of the contract (Step S508).

If today is the automatic renewal day of the contract, the contract period renewal module 114 renews the contract period for only a predetermined period (Step S509). The contract period renewal process may be performed through the communication unit 120. The predetermined period may be as long as the original contract period or may be specified by the user when the automatic renewal day is registered. If the document of the contract 400 is acquired through the OCR process or from another storage media, the user may be informed to renew the contract because the contract period cannot be automatically renewed through the communication unit 120.

In this example, the flow in which the contract period automatic renewal process in the steps S508 and S509 is performed after the automatic renewal day of a contract is registered is described. The steps S508 and S509 should be performed every day when an automatic renewal day is registered. Moreover, if the automatic renewal days of two or more contracts are registered in the system for managing a contract, the steps S508 and S509 should be repeated for each contract.

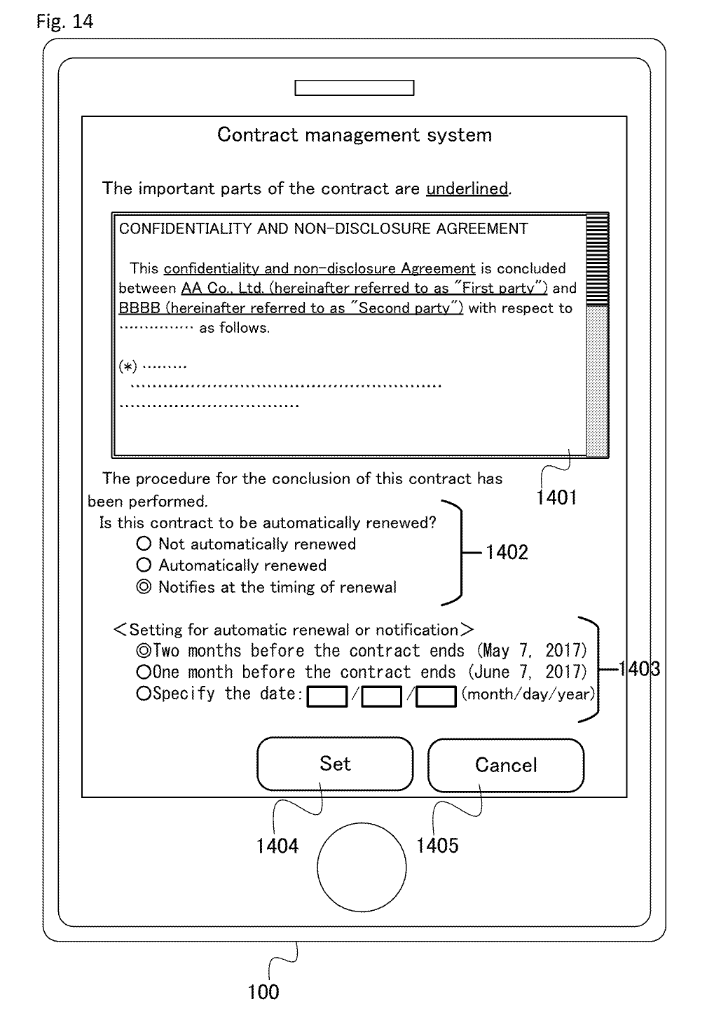

FIG. 14 shows one example displayed by the contract period renewal process. This screen may be displayed after the conclusion button 1302 shown in FIG. 13 is selected to conclude a contract. In this example, the display unit 1401 displays a contract 400 and the conclusion of the contract 400 in the center of the screen because the procedure for the conclusion was performed. The bottom of this screen enables the user to set whether or not the contract is automatically renewed. The option 1402 enables the user to select “Not automatically renewed,” “Automatically renewed,” or “Notifies at the timing of renewal” by radio buttons. In this example, the user selects “Notifies at the timing of renewal.” If the user selects “Automatically renewed” or “Notifies at the timing of renewal,” the option 1403 enables the user to select what date the contract is automatically renewed or what date the user is to be notified. The option 1403 enables the user to select one of “Two months before the contract ends (May 7, 2017),” “One month before the contract ends (Jun. 7, 2017),” and “Specify the date.” In this example, the user selects “Two months before the contract ends (May 7, 2017).” If the user selects “Specify the date,” the option enables the user to input or select an appropriate date. Although not shown in FIG. 14, this option may enable the user to select a time in addition to a date. After the options 1402 and 1403, the set button 1404 is selected to register the automatic renewal day. If the cancel button 1405 is selected, this screen may be closed to enable the user to set the automatic renewal later, or the process is ended, presuming no automatic renewal.

As described above, the present invention can provide a system, a method, and a program for managing a contract to clearly display information including the contract period, the type, and the counterparty of the contract that is important for a user who makes a contract on the screen, etc., of a terminal, previously inform the risk, and appropriately renew and manage the contract.

### Contract Categorizing Function

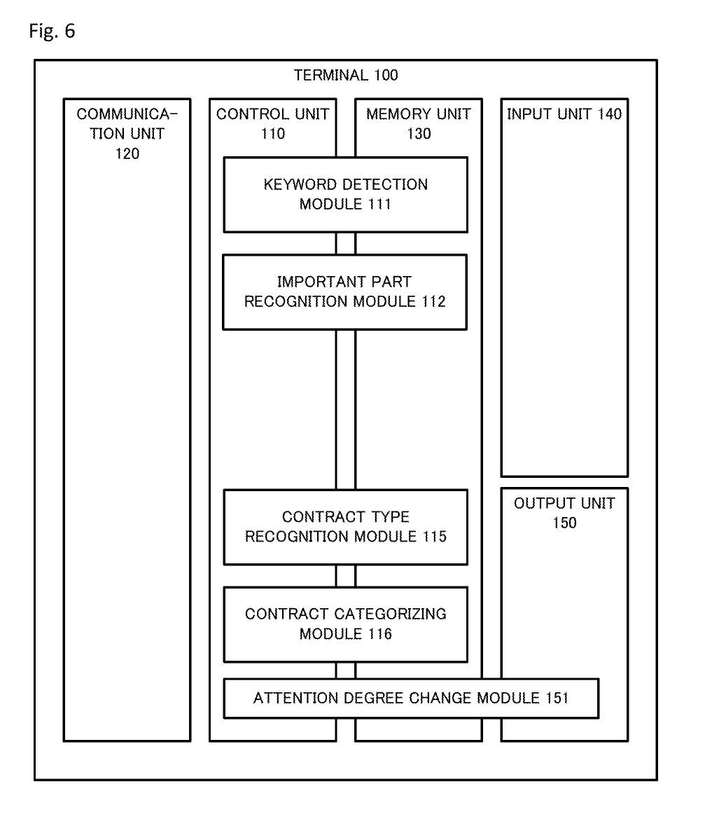

FIG. 6 shows a functional block diagram of the terminal 100 with a contract categorizing function to show the relationship among the functions. In addition to the configuration shown in FIG. 2, the control unit 110 of the terminal 100 achieves a contract type recognition module 115 and a contract categorizing module 116 in cooperation with the memory unit 130.

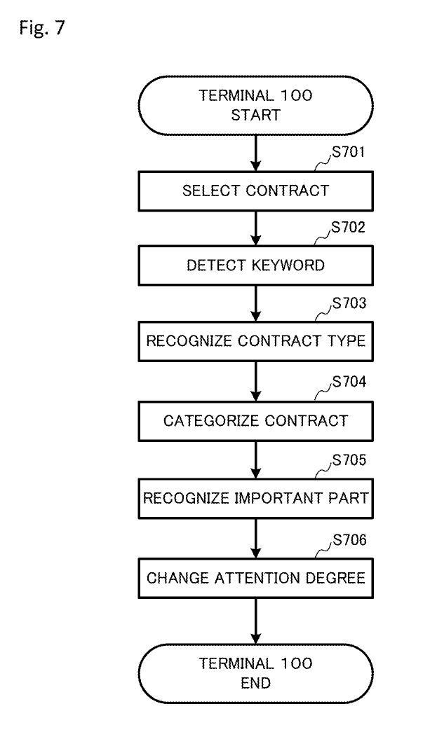

FIG. 7 shows a flow chart of the contract categorizing process performed by the terminal 100. The tasks executed by the modules will be described below with this process. Since the process of the steps S701 to S702 shown in FIG. 7 corresponds to that of the steps S301 to S302 shown in FIG. 3, the process from the step S703 will be described below.

After the keyword detection module 111 detects a keyword, the contract type recognition module 115 recognizes the contract type (Step S703). The contract type is recognized at this point based on the keywords detected in the step S702. For example, if the keyword “confidentiality agreement” is detected in the step S702, the contract type recognition module 115 recognizes the contract type is “confidentiality agreement”. To recognize the contract type, contract types such as “confidentiality agreement”, “sales contract”, and “business trust agreement” are preferably registered as the keywords. Furthermore, the keywords may include “license agreement” and “license” according to the type of the contract that the system for managing a contract deals with.

If the contract type itself is detected based on the keywords, the contract type can be easily recognized. However, if not, the contract type is analogized from the entire text. To analogize the contract type, a person may learn the contract type from a teacher or may use machine learning and deep learning. For the learning, a large amount of data is needed so that the contract type recognition module 115 that has learned a contract type may be acquired from the outside through the communication unit 120 or may be acquired by connecting the terminal 100 with another storage media.

Then, the contract categorizing module 116 categorizes the contract based on the recognized contract type (Step S704). At this point, if more than two contracts exist in the system for managing a contract, the contract categorizing process can sort and list the contracts by type. Moreover, other keywords such as contract period, counterpart, risk, and payment are registered so that the contracts can be sort and listed based on these keywords.

Then, the important part recognition module 112 recognizes an important part based on the keywords detected in the step S702 (Step S705). Examples of the important part at this point include a contract period, a counterpart, a risk, and a payment in addition to a contract type recognized in the step S703.

To recognize an important part, a person may learn the important part from a teacher or may use machine learning and deep learning. For the learning, a large amount of data is needed so that the important part recognition module 112 that has learned an important part may be acquired from the outside through the communication unit 120.

Finally, the attention degree change module 151 changes the attention degree to each recognized important part (Step S706). Specifically, in the attention degree process, the important parts may be underlined, highlighted, blinked, changed in text color, changed in background color, displayed with a mark indicating the importance, or displayed with the important reason in a contract 400 displayed on the output unit 150 of the terminal 100. If the important parts are output by voices, the start and end of each important part may be guided audibly.

As described above, the present invention can provide a system, a method, and a program for managing a contract to clearly display information including the contract period, the type, and the counterparty of the contract that is important for a user who makes a contract on the screen, etc., of a terminal, previously inform the risk, and appropriately manage the contract.

System for Managing a Contract that Includes a Terminal 100 and a Computer 200

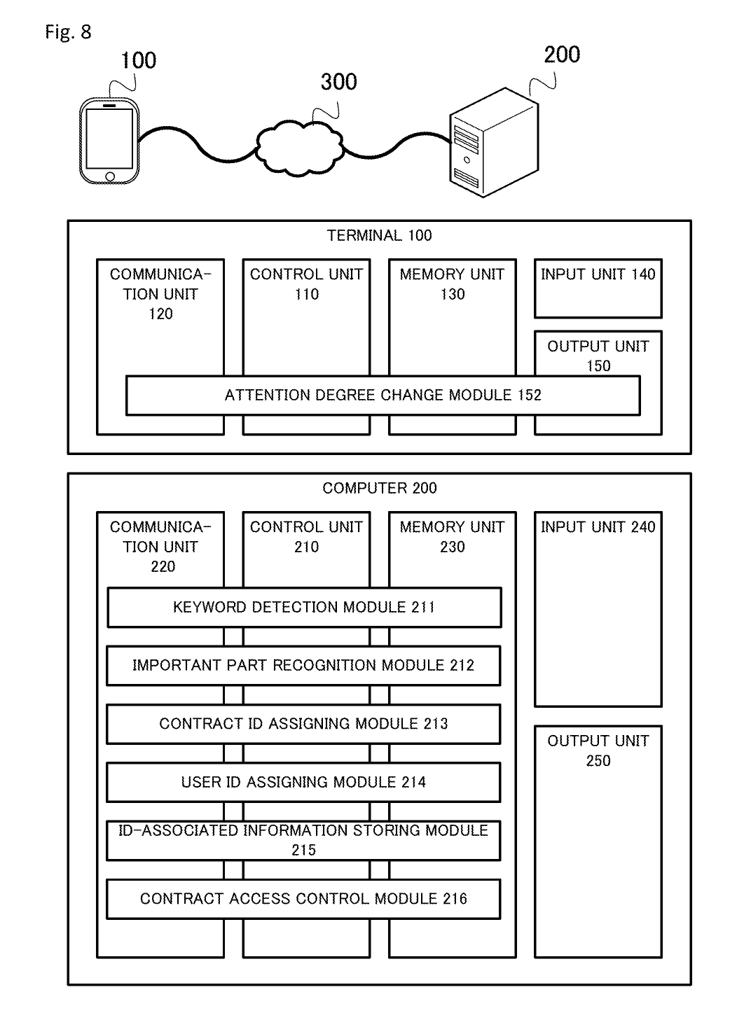

The system for managing a contract that includes a terminal 100 and a computer 200 will be described below. FIG. 8 shows a functional block diagram of the terminal 100 and the computer 200 with an ID-associated information storing function and a contract access control function to show the relationship among the functions. The terminal 100 and the computer 200 are connective with each other through a communication network 300. The terminal 100 includes a control unit 110, a communication unit 120, a memory unit 130, an input unit 140, and an output unit 150. The output unit 150 achieves an attention degree change module 152 in cooperation with the control unit 110, the communication unit 120, and the memory unit 130. The computer 200 includes a control unit 210, a communication unit 220, a memory unit 230, an input unit 240, and an output unit 250. The control unit 210 achieves a keyword detection module 211, an important part recognition module 212, a contract ID assigning module 213, a user ID assigning module 214, an ID-associated information storing module 215, and a contract access control module 216 in connection with the communication unit 220 and the memory unit 230. The communication network 300 may be a public line network such as the Internet or a private line network.

The terminal 100 is a terminal device that is capable of data communication with the computer 200, which is owned by the user who uses the system for managing a contract. Examples of the terminal 100 include electrical appliances such as a mobile phone, a mobile information terminal, a tablet terminal, a personal computer, a net book terminal, a slate terminal, an electronic book terminal, and a portable music player, and wearable terminals such as smart glasses and a head mounted display. The smart phone shown as the terminal 100 in the attached drawings is just one example.

The terminal 100 includes a control unit 110 provided with CPU, RAM, ROM, etc.

The communication unit 120 includes a device that is communicative to other devices, such as a Wi-Fi® enabled device complying with, for example, IEEE 802.11, or a wireless device complying with the IMT-2000 standard such as the third and the fourth generation mobile communication systems. The communication unit may include a wired device for LAN connection.

The memory unit 130 includes a data storage unit such as a hard disk or a semiconductor memory to store the data necessary for the process that include the content of the contract 400 and important parts.

The input unit 140 has a function necessary to use the system for managing a contract. As an example to achieve the input, the input unit 140 may include a liquid crystal display with a touch panel function, a keyboard, a mouse, a pen tablet, a hardware button on the device, and a microphone to perform voice recognition. The features of the present invention are not limited in particular by the input method.

The output unit 150 has a function necessary to use the system for managing a contract. The output unit 150 achieves an attention degree change module 152 in cooperation with the control unit 110, the communication unit 120, and the memory unit 130. As an example to achieve the output, the output unit 130 may take forms such as a liquid crystal display, a PC display, and a projector to display images and output voices. The features of the present invention are not limited in particular by the output method.

The computer 200 may be a general computer provided with the functions to be described later.

The computer 200 includes a control unit 210 provided with CPU, RAM, ROM, etc. The control unit 210 achieves a keyword detection module 211, an important part recognition module 212, a contract ID assigning module 213, a user ID assigning module 214, an ID-associated information storing module 215, and a contract access control module 216 in connection with the communication unit 220 and the memory unit 230.

The communication unit 220 includes a device that is communicative to other devices, such as a Wi-Fi® enabled device complying with, for example, IEEE 802.11, or a wireless device complying with the IMT-2000 standard such as the third and the fourth generation mobile communication systems. The communication unit may include a wired device for LAN connection.

The memory unit 230 includes a data storage unit such as a hard disk or a semiconductor memory to store the data necessary for the process that include the contents of contracts 400, keywords, important parts, contract IDs, user IDs, and ID-associated information.

The input unit 240 has a function necessary to manage the system for managing a contract. As an example to achieve the input, the input unit 240 may include a liquid crystal display with a touch panel function, a keyboard, a mouse, a pen tablet, a hardware button on the device, and a microphone to perform voice recognition. The features of the present invention are not limited in particular by the input method.

The output unit 250 has a function necessary to manage the system for managing a contract. As an example to achieve the output, the output unit 130 may take forms such as a liquid crystal display, a PC display, and a projector to display images and output voices. The features of the present invention are not limited in particular by the output method.

### ID-Associated Information Storing Function

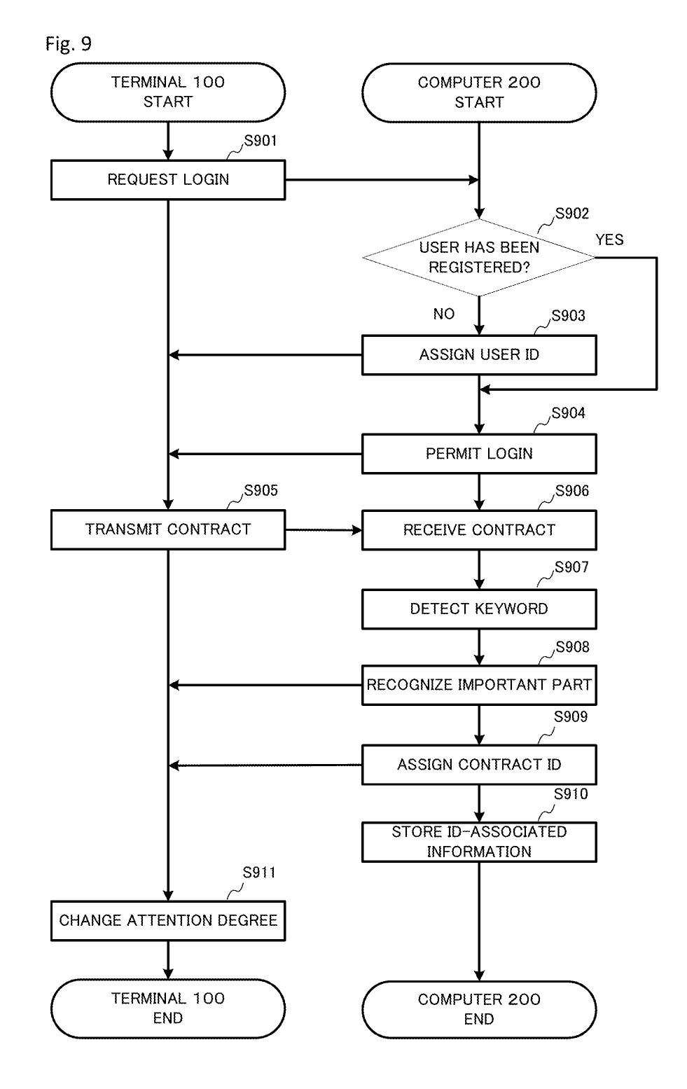

FIG. 9 shows a flow chart of the ID-associated information storing process performed by the terminal 100 and the computer 200. The tasks executed by the modules of each of the above-mentioned devices will be explained below together with this process.

First, the control unit 110 of the terminal 100 transmits a login request to the computer 200 through the communication unit 120 (Step S901). The user who has already been registered in the system for managing a contract transmits account information and authentication information that are necessary for login to the computer 200, together with the login request. The account information includes a name and a nickname. The authentication information includes a password, a passphrase, an IC card, a smart card, a fingerprint, and an iris. The user who has not been registered in the system for managing a contract does not have account information or authentication information. In this case, a user registration request may be transmitted together with a login request.

The computer 200 checks whether or not the user has been registered in the system for managing a contract in response to a login request from the terminal 100 (Step S902).

If the computer 200 receives a user registration request from the user who has not been registered in the system for managing a contract, the user ID assigning module 214 assigns a user ID to the user of the terminal 100 and prompts the user to register account information and authentication information associated with the user ID (Step S903). If the user has been registered, the process proceeds to the step S904.

Then, the computer 200 transmits a login permission to the terminal 100 (Step S904). In this example, the flow chart shows that the login succeeds for simplification. However, if the login fails, the computer 200 may prompt the user to retry the login. If the login fails more than a certain number of times, the computer 200 may lock the account and end the login process.

After the login to the system for managing a contract, the terminal 100 transmits a contract 400 that is to be managed by the system for managing a contract to the computer 200 (Step S905).

The computer 200 receives the contract 400 through the communication unit 220 and stores in the memory unit 230 (Step S906).

Then, the keyword detection module 211 of the computer 200 detects a keyword in the contract 400 (Step S907).

The keyword is a word or a phrase that can be used to judge the contract period, the contract type, the contractor, the counterpart, the risk, the payment, etc. Examples of the keyword to judge the contract period may include date, contract day, and validity. Examples of the keyword to judge the contract type may include confidentiality, sales, job commission, and licensing. Examples of the keyword to judge the counterpart may include company, first party, second party, chairman, president, director, and manager. Examples of the keyword to judge the risk and the payment may include damage compensation, obligation, liability, must, prohibition, payment, consideration, and yen. The keyword may be input by the user with the input unit 140 of the terminal 100 or by the administrator with the input unit 240 of the computer 200. Moreover, the keyword may be acquired from the outside through the communication unit 220 of the computer 200 or may be acquired by connecting the computer 200 with another storage media.

Then, the important part recognition module 212 of the terminal 200 recognizes an important part based on the detected keywords and transmits the important part to the terminal 100 (Step S908). The important part herein is important for the user (contractor) who makes a contract. Examples of the important part include a contract period, a contract type, a counterpart, a risk, and a payment. To recognize an important part, a person may learn the important part from a teacher or may use machine learning and deep learning.

Then, the contract ID assigning module 213 assigns a contract ID to the contract 400 (Step S909). At this point, the assigned contract ID is notified to the terminal 100 and stored in the memory unit 130 of the terminal 100. The contract ID may be stored together with a contract period, a contract type, a counterpart, etc.

After the contract ID assigning module 213 assigns contract ID, the ID-associated information storing module 215 stores the ID-associated information in the memory unit 230 (Step S910). The ID-associated information herein associates the user ID that a user is logging in the system for managing a contract has with the contract ID of a contract 400.

Finally, the attention degree change module 151 of the terminal 100 changes the attention degree based on each recognized important part received from the computer 200 (Step S911). Specifically, in the attention degree process, the important parts may be underlined, highlighted, blinked, changed in text color, changed in background color, displayed with a mark indicating the importance, or displayed with the important reason in a contract 400 displayed on the output unit 150 of the terminal 100. If the important parts are output by voices, the start and end of each important part may be guided audibly.

FIG. 13 shows one example displayed by the attention degree change process of the terminal 100. The details of this process are as described above. Even if the computer 200 performs the keyword detection process and the important part recognition process, the terminal 100 can display the content in the same way.

As described above, the present invention can provide a system, a method, and a program for managing a contract to clearly display information including the contract period, the type, and the counterparty of the contract that is important for a user who makes a contract on the screen, etc., of a terminal, and previously inform the risk.

### Contract Access Control Function

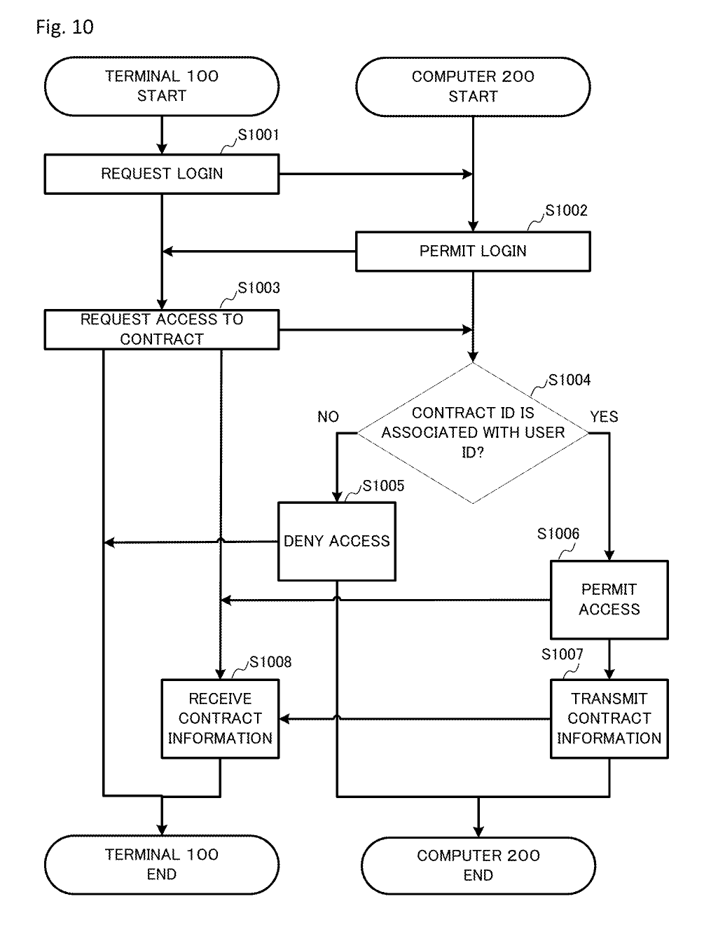

FIG. 10 shows a flow chart of the contract access control process performed by the terminal 100 and the computer 200. The tasks executed by the modules of each of the above-mentioned devices will be explained below together with this process.

First, the control unit 110 of the terminal 100 transmits a login request to the computer 200 through the communication unit 120 (Step S1001). Assuming that the user has already been registered in the system for managing a contract, the control unit 110 transmits account information and authentication information that are necessary for login to the computer 200, together with the login request. The account information includes a name and a nickname. The authentication information includes a password, a passphrase, an IC card, a smart card, a fingerprint, and an iris. If the terminal 100 has a user ID, the user ID may also be transmitted.

Then, the computer 200 transmits a login permission to the terminal 100 (Step S1002). The flow chart illustrates that the login is succeeded for simplification. However, if the login fails, the login process may prompt to the user to try the login again. If the login fails a certain number of times, the login process may freeze the account and then ends.

After the login to the system for managing a contract, the terminal 100 transmits an access request to a contract 400 that is managed by the system for managing a contract (Step S1003). The access request includes the contract ID of a contract to be accessed.

The contract access control module 216 of the computer 200 checks whether or not the contract ID of the contract that is requested to be accessed and the user ID of the user that is currently logging in are stored as ID-associated information (Step S1004).

If the contract ID or the user ID is not stored as ID-associated information, the contract access control module 216 transmits an access denial to the terminal 100 (Step S1005).

If the contract ID and the user ID are stored as ID-associated information, the contract access control module 216 transmits an access permit to the terminal 100 (Step S1006).

Then, the contract access control module 216 transmits contract information that is requested to be accessed to the terminal 100 (Step S1007). The contract information herein may include not only the text of a contract but also a detected keyword and a recognized important part.

The terminal 100 receives the contract information from the computer 200 (Step S1008). The received information can be output to the output unit 150 of the terminal 100 to enable the user to check the content.

In this example, the contract ID is stored in the memory unit 130 of the terminal 100. However, the computer 200 may transmit information associated with the titles, the keywords, and the contract IDs of the two or more of contracts to the terminal 100 as a list and prompt the user select a contract to be accessed from the list. In this case, the contract ID of the selected contract only has to be transmitted on a contract access request (Step S1003).

As described above, the present invention can provide a system, a method, and a program for managing a contract to appropriately manage the contract.

### Contract Risk Judgment Function

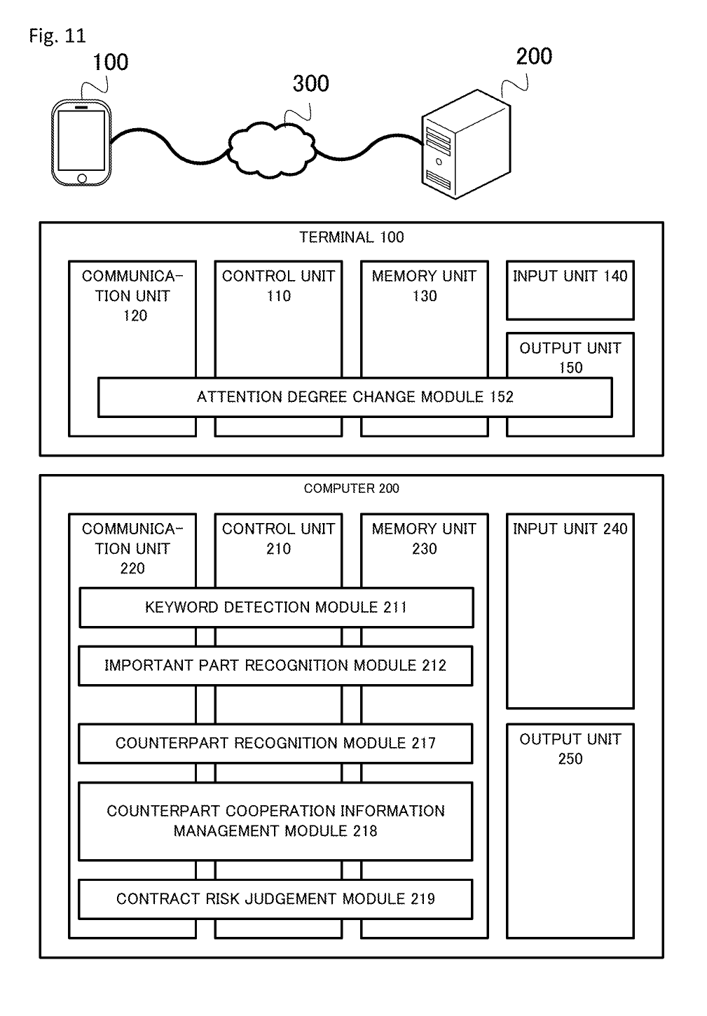

FIG. 11 shows a functional block diagram of the terminal 100 and the computer 200 with a risk judgement function to show the relationship among the functions. The terminal 100 and the computer 200 are connective with each other through a communication network 300. The terminal 100 includes a control unit 110, a communication unit 120, a memory unit 130, an input unit 140, and an output unit 150. The output unit 150 achieves an attention degree change module 152 in cooperation with the control unit 110, the communication unit 120, and the memory unit 130. The computer 200 includes a control unit 210, a communication unit 220, a memory unit 230, an input unit 240, and an output unit 250. The control unit 210 achieves a keyword detection module 211, an important part recognition module 212, a counterpart recognition module 217, a counterpart cooperation information management module 218, a contract risk judgement module 219 in connection with the communication unit 220 and the memory unit 230. The communication network 300 may be a public line network such as the Internet or a private line network.

The terminal 100 is a terminal device that is capable of data communication with the computer 200, which is owned by the user. Examples of the terminal 100 include electrical appliances such as a mobile phone, a mobile information terminal, a tablet terminal, a personal computer, a net book terminal, a slate terminal, an electronic book terminal, and a portable music player, and wearable terminals such as smart glasses and a head mounted display. The smart phone shown as the terminal 100 in the attached drawings is just one example.

The terminal 100 includes a control unit 110 provided with CPU, RAM, ROM, etc.

The communication unit 120 includes a device that is communicative to other devices, such as a Wi-Fi® enabled device complying with, for example, IEEE 802.11, or a wireless device complying with the IMT-2000 standard such as the third and the fourth generation mobile communication systems. The communication unit may include a wired device for LAN connection.

The memory unit 130 includes a data storage unit such as a hard disk or a semiconductor memory to store the data necessary for the process that include the content of the contract 400 and important parts.

The input unit 140 has a function necessary to use the system for managing a contract. As an example to achieve the input, the input unit 140 may include a liquid crystal display with a touch panel function, a keyboard, a mouse, a pen tablet, a hardware button on the device, and a microphone to perform voice recognition. The features of the present invention are not limited in particular by the input method.

The output unit 150 has a function necessary to use the system for managing a contract. The output unit 150 achieves an attention degree change module 152 in cooperation with the control unit 110, the communication unit 120, and the memory unit 130. As an example to achieve the output, the output unit 130 may take forms such as a liquid crystal display, a PC display, and a projector to display images and output voices. The features of the present invention are not limited in particular by the output method.

The computer 200 may be a general computer provided with the functions to be described later.

The computer 200 includes a control unit 210 provided with CPU, RAM, ROM, etc. The control unit 210 achieves a keyword detection module 211, an important part recognition module 212, a counterpart recognition module 217, a counterpart cooperation information management module 218, a contract risk judgement module 219 in connection with the communication unit 220 and the memory unit 230.

The communication unit 220 includes a device that is communicative to other devices, such as a Wi-Fi® enabled device complying with, for example, IEEE 802.11, or a wireless device complying with the IMT-2000 standard such as the third and the fourth generation mobile communication systems. The communication unit may include a wired device for LAN connection.

The memory unit 230 includes a data storage unit such as a hard disk or a semiconductor memory to store the data necessary for the process that include the contents of contracts 400, keywords, important parts, contract IDs, user IDs, and ID-associated information.

The input unit 240 has a function necessary to manage the system for managing a contract. As an example to achieve the input, the input unit 140 may include a liquid crystal display with a touch panel function, a keyboard, a mouse, a pen tablet, a hardware button on the device, and a microphone to perform voice recognition. The features of the present invention are not limited in particular by the input method.

The output unit 250 has a function necessary to manage the system for managing a contract. As an example to achieve the output, the output unit 130 may take forms such as a liquid crystal display, a PC display, and a projector to display images and output voices. The features of the present invention are not limited in particular by the output method.

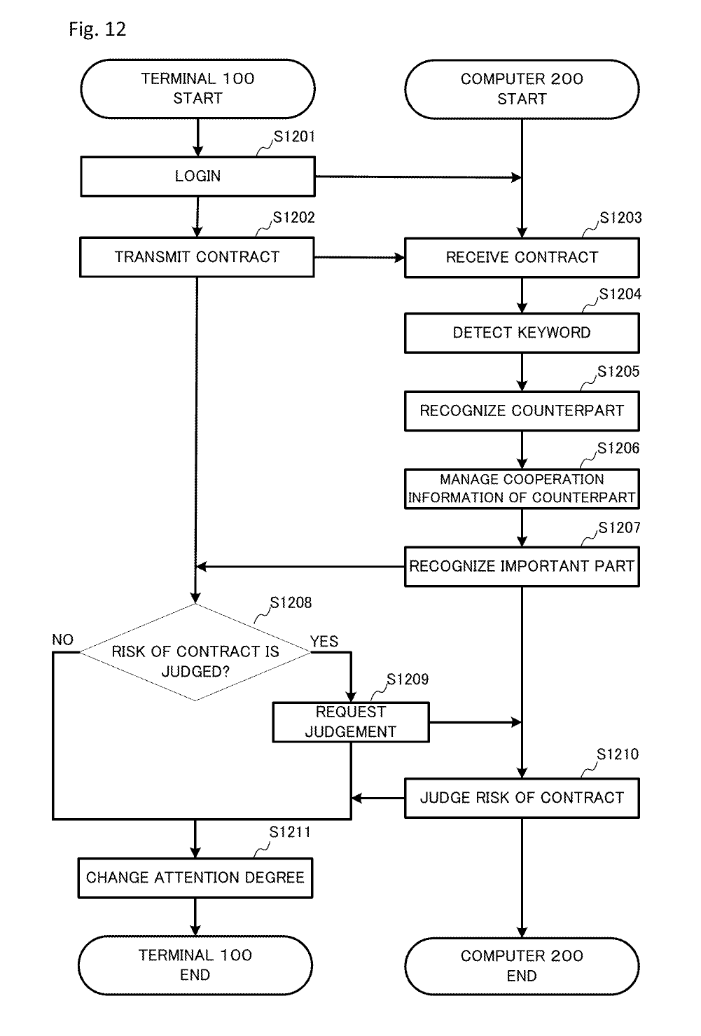

FIG. 12 shows a flow chart of the contract risk judgement process. The tasks executed by the modules of each of the above-mentioned devices will be explained below together with this process.

First, the control unit 110 of the terminal 100 transmits a login request to the computer 200 through the communication unit 120 (Step S1201). Assuming that the user has already been registered in the system for managing a contract, the control unit 110 transmits account information and authentication information that are necessary for login to the computer 200, together with the login request. The account information includes a name and a nickname. The authentication information includes a password, a passphrase, an IC card, a smart card, a fingerprint, and an iris. If the terminal 100 has a user ID, the user ID may also be transmitted. The flow chart illustrates that the login is succeeded for simplification. However, if the login fails, the login process may prompt to the user to try the login again. If the login fails a certain number of times, the login process may freeze the account and then ends.

After the login to the system for managing a contract, the terminal 100 transmits a contract 400 with the risk to be judged by the system for managing a contract to the computer 200 (Step S1202).

The computer 200 receives the contract 400 through the communication unit 220 and stores in the memory unit 230 (Step S1203).

Then, the keyword detection module 211 of the computer 200 detects a keyword in the contract 400 (Step S1204).

The keyword is a word or a phrase that can be used to judge the contract period, the contract type, the contractor, the counterpart, the risk, the payment, etc. Examples of the keyword to judge the contract period may include date, contract day, and validity. Examples of the keyword to judge the contract type may include confidentiality, sales, job commission, and licensing. Examples of the keyword to judge the counterpart may include company, first party, second party, chairman, president, director, and manager. Examples of the keyword to judge the risk and the payment may include damage compensation, obligation, liability, must, prohibition, payment, consideration, and yen. The keyword may be input by the user with the input unit 140 of the terminal 100 or by the administrator with the input unit 240 of the computer 200. Moreover, the keyword may be acquired from the outside through the communication unit 220 of the computer 200 or may be acquired by connecting the computer 200 with another storage media.

The counterpart recognition module 217 recognizes a counterpart based on the detected keywords (Step S1205). For example, if the keywords “first party” and “second party” are detected in the step S1204, the contexts before and after the keyword “AA Co., Ltd. (hereinafter referred to as “First party”)” and “BBBB (hereinafter referred to as “Second party”),” the contexts of the entire contract, the signature at the end of the contract, and the like are checked to recognize “AA Co., Ltd” as the counterpart. To recognize the counterpart, a person may learn the important part from a teacher or may use machine learning and deep learning.

Then, the counterpart cooperation information management module 218 manages the corporate information of the counterpart (Step S1206). For example, the counterpart cooperation information management module 218 acquires the stock price, the press release, the word of mouth, etc. from the Internet, etc., as the corporate information of the counterpart. The acquired corporate information is associated with the contract ID and the acquisition date and stored in the memory unit 230.

The important part recognition module 212 recognizes an important part based on the keywords and the cooperation information of the counterpart and transmits the important part to the terminal 100 (Step S1207). The important part herein is important for the user (contractor) who makes a contract. Examples of the important part include a contract period, a contract type, a counterpart, a risk, and a payment. To recognize an important part, a person may learn the important part from a teacher or may use machine learning and deep learning.

After receiving the important part, the terminal 100 checks whether or not to judge the risk of the contract (Step S1208). The output unit 150 of the terminal 100 may display an option to judge the risk of the contract to enable the user to select.

If judging the risk of the contract, the terminal 100 transmits a judgment request to the computer 200 (Step S1209).

If the computer 200 receives the judgment request for the risk of the contract, the contract risk judgement module 219 of the computer 200 judges the risk of the contract and transmits the judgement information on the risk of the contract to the terminal 100 (Step S1210). The contract risk is judged based on the detected keyword, the counterpart, and the corporate information of the counterpart. To judge the risk of the contract, a person may learn the risk of the contract from a teacher or may use machine learning and deep learning. The risk of the contract may be represented by, for example, “high, medium, and low” or in percentage in stages.

Finally, the attention degree change module 151 of the terminal 100 changes the attention degree based on the received important parts and the judgement information on the risk of the contract that are received from the computer 200 (Step S1211). If no information on the risk of the contract exists, the attention degree is changed based on only the important parts. To change the attention degree, in the attention degree process, the important parts may be underlined, highlighted, blinked, changed in text color, changed in background color, displayed with a mark indicating the importance, or displayed with the important reason in a contract 400 displayed on the output unit 150 of the terminal 100. If the important parts are output by voices, the start and end of each important part may be guided audibly.

FIG. 15 shows one example displayed by the contract risk judgement process. This screen may be displayed by selecting the risk details display button 1304 shown in FIG. 13. The attention degree change module 152 outputs the content of the contract 400 on the display unit 1501 of the terminal 100 while changing the attention degree to each important part. In this example, the risk information indicates a risk 1 displayed in the balloon 1502 and a risk 2 displayed in the balloon 1503. Moreover, the display unit 1504 displays details about the risks 1 and 2. In FIG. 15, the content of the risk 1 is “The stock price of AA Co., Ltd has sharply fallen for these three months,” and the content of the risk 2 is “The obligation after the contract ends is standardly continued for “three years.” “Five years” are long.” In this example, the total risk degree based on the two or more risks has three steps: high, medium, and low, and the total risk degree display 1505 displays that the total risk degree is middle. Selecting the conclusion button 1506 on this screen concludes this contract. If a contract 400 is acquired through the communication unit 120, the contract conclusion process may be continued by the control unit 110 through the communication unit 120. If a written contract 400 is acquired by an OCR process, the conclusion of the contract in writing may be stored in the memory unit 130 of the terminal 100. Selecting the no conclusion button 1507 does not perform the conclusion process for the contract. If a contract 400 is acquired through the communication unit 120, the contract conclusion process may be ended by the control unit 110 through the communication unit 120. If a written contract 400 is acquired by an OCR process, the no-conclusion of the contract in writing may be stored in the memory unit 130 of the terminal 100. After the process of the conclusion button 1506 and the no conclusion button 1507 ends, the system for managing a contract may be ended, or the menu screen, etc., of the system for managing a contract may be displayed.

As described above, the present invention can provide a system, a method, and a program for managing a contract to clearly display information including the contract period, the type, and the counterparty of the contract that is important for a user who makes a contract on the screen, etc., of a terminal, and previously inform the risk.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), DVD (e.g., DVD-ROM, DVD-RAM), or a compact memory. In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

100 Terminal
200 Computer
300 Communication network
400 Contract

1. A system for managing a contract, comprising:
a keyword detection unit that detects a predetermined keyword in the text of the contract;
an important part recognition unit that recognizes an important part for a user who makes a contract based on the detected keywords;
an attention degree change unit that changes an attention degree to the recognized important part;
a counterpart recognition unit that recognizes a counterpart based on the detected keywords; and
a counterpart corporate information management unit that manages corporate information on the recognized counterpart,
wherein the important part recognition unit recognizes the important part based on the counterpart or the corporate information thereof.

2. The system according to claim 1, further comprising: a contract period recognition unit that recognizes the contract period based on the detected keywords; and a contract period renewal unit that renews the recognized contract period to a predetermined period.

3. The system according to claim 1, further comprising: a contract type recognition unit that recognizes the contract type based on the detected keywords; and a contract categorizing unit that categorizes the contract based on the recognized contract type.

4. The system according to claim 1, further comprising: a contract ID assigning unit that assigns an ID to the contract; a user ID assigning unit that assigns an ID to the user; an ID-associated information storing unit that associates and stores the contract ID with the user ID as ID-associated information; and a contract access control unit that controls an access from the user to the contract based on the stored ID-associated information.

5. (canceled)

6. The system according to claim 1, further comprising a contract risk judgment unit that judges the risk of the contract based on at least one of the detected keyword, the detected counterpart, and the corporate information thereof, wherein the attention degree change unit displays an attention degree in stages according to the judged risk of the contract.

7. A method for managing a contract, comprising the steps of:
detecting a predetermined keyword in the text of the contract;
recognizing an important part for a user who makes a contract based on the detected keywords;
changing an attention degree to the recognized important part;
recognizing a counterpart based on the detected keywords; and
managing corporate information on the recognized counterpart,
wherein the recognizing an important part includes recognizing the important part based on the counterpart or the corporate information thereof.

8. A computer program product for use in a system for managing a contract, comprising a non-transitory computer usable medium having a set of instructions physically embodied therein, the set of instructions including computer readable program code, which when executed by the system causes an information processing unit to:
detect a predetermined keyword in the text of the contract;
recognize an important part for a user who makes a contract based on the detected keywords;
change an attention degree to the recognized important part;
recognize a counterpart based on the detected keywords; and
manage corporate information on the recognized counterpart,
wherein the recognizing an important part includes recognizing the important part based on the counterpart or the corporate information thereof.
